(19) United States
(12) Patent Application Publication
(10) Pub. No.: US 2024/0375297 A1
(43) Pub. Date: Nov. 14, 2024

(54) SYSTEM FOR HANDLING SEPARATION LAYERS IN A PRODUCTION PROCESS

(71) Applicant: AKTIEBOLAGET SKF, GOTEBORG (SE)

(72) Inventor: Helge KOOPMANN, Gartow (DE)

(21) Appl. No.: 18/655,451

(22) Filed: May 6, 2024

(30) Foreign Application Priority Data
May 12, 2023 (DE) 102023204458.7

(51) Int. Cl. B25J 15/06; B65D 57/00

(52) U.S. Cl. CPC B25J 15/0683; B65D 57/004

(57) ABSTRACT

A system for handling separation layers in a production process includes at least one separation layer and a handling apparatus. The handling apparatus is preferably a vacuum gripper and is provided to move the separation layer. The separation layer has at least one slot which facilitates bending of the separation layer during lifting of the layer by the handling apparatus, such bending releasing the separation layer being lifted from another separation layer located in a stack of separation layers beneath the lifted layer.

### CROSS-REFERENCE

This application claims priority to German patent application no. 102023204458.7 filed on May 12, 2023, the contents of which are fully incorporated herein by reference.

### BACKGROUND OF THE INVENTION

The present invention relates to material handling systems, and more particularly to a system for handling separation layers used in a production process.

During the production of mechanical components, such as for example, bearing components, the processing of such components is often performed in automated production lines. At the end of a production line, robot cells which palletize the processed components may be provided. Depending on the size of the components, the components may be positioned in layers during the palletization. During such as process, separation layers may be used in order to separate the individual component layers from each other, such separation layers being typically formed as a sheet of a flexible material. These separation layers are generally re-used and are therefore collected and stacked after each use in order to store the layers in a space-saving manner until they are used once again.

During the production of bearing components, a series of fluids are typically used, such as for example, conservation fluid, lubricant, etc., which may be carried by the processed components and which can contaminate the separation layers. These fluids often result in the separation layers bonding together when the layers are stacked. Such bonding may cause a gripping robot, which is intended to grip only a single separation layer from the stacked separation layers, to raise a plurality of separation layers at one time. This creates the risk of one or more of the bonded separation layers becoming detached and disrupting the production process.

In order to prevent the bonding or adhesion of stacked separation layers, it is known to install a washing process before the separation layers are re-used. However, such a washing process is work-intensive and increases manufacturing costs.

### SUMMARY OF THE INVENTION

Therefore, an object of the present invention is to provide a system for handling separation layers in a production process which allows the washing process and the costs involved therewith to be saved.

This object is achieved by a system for handling separation layers in a production process which basically comprises at least one separation layer having at least one slot and a handling apparatus configured to move the separation layer.

More specifically, a system for handling separation layers in a production process which has at least one separation layer and one handling apparatus is proposed in detail below. The handling apparatus is preferably a vacuum gripper and is configured to move the separation layer. In particular, the handling apparatus can be configured to raise and to move a separation layer from a stack comprising a plurality of the separation layers, for example, the uppermost separation layer. Each separation layer may be used, for example, to separate two layers of finished components in a production process. The finished components may be, for example, bearing components, specifically inner rings, outer rings, etc.

Preferably, the at least one separation layer is produced from a flexible plastic material. For example, the at least one separation layer may be produced from acrylonitrile butadiene styrene copolymer (“ABS”). ABS advantageously has a good resistance to oils and/or fats. Furthermore, the at least one separation layer may have a thickness between 1 mm and 5 mm, preferably a thickness between 2 mm to 3 mm. Such thicknesses allow the separation layer to be configured or formed in a flexible manner. The separation layer preferably has a rectangular shape, but may alternatively have another suitable shape, such as for example, an oval shape, a circular shape, etc.

In order to prevent the handling apparatus from raising or lifting more than one separation layer from a stack of separation layers due to bonding between layers, each separation layer is provided with at least one slot. Furthermore, the separation layer has a face or surface which is surrounded by an edge, such that the slot is provided completely within the face. In other words, the at least one slot is fitted to or disposed within the separation layer so that the slot does not extend as far as the edge of the separation layer.

In particular, the handling apparatus may cooperate with the separation layer so that, when the separation layer is raised and/or moved, the separation layer bends at least partially. As a result of the bending of the separation layer, the at least one slot preferably opens at least partially. Such opening of the slot facilitates detachment of the uppermost separation layer from the separation layer below or beneath the layer being raised.

Furthermore, the separation layer may have a plurality of slots which are arranged in a state distributed uniformly and/or symmetrically. A uniform and/or symmetrical distribution of the slots allows uniform and/or symmetrical bending of the separation layer when the separation layer is raised and/or moved by the handling apparatus, whereby easier separation or detachment of the separation layer from the separation layer below may be achieved.

In particular, the separation layer may have two slots, three slots, four slots or even more than four slots. For example, in the case of a rectangular separation layer, four slots can be provided, wherein each one of the four slots is orientated towards a separate one of the four corners of the separation layer. Alternatively, in the case of a circular or oval separation layer, the slots may be arranged in a state distributed circumferentially and uniformly on the layer.

Furthermore, the at least one slot may be located or disposed so as to at least partially surround at least one predetermined location at a predetermined spacing. In particular, the at least one slot can be angular and/or in the form of a circular arc. In the case of a rectangular separation layer, for example, the at least one slot may be formed in an L-shaped manner, wherein each leg of the L-shaped slot is arranged parallel with a separate one of the sides of the separation layer. Preferably, the tip or corner of the L-shaped slot, that is to say, the location at which the two legs meet each other or intersect, is directed toward a center of the separation layer. Bending of the separation layer during lifting and/or moving of the separation layer by the handling apparatus can thereby be improved, whereby any bonding or adherence of the separation layers to each other can be released more easily by the handling apparatus.

Preferably, the handling apparatus has at least one gripping device which is configured to grip the separation layer at least at one predetermined location. Preferably, the at least one predetermined location is adjacent to the at least one slot formed in the separation layer. Such a relative positioning of the at least one slot and the predetermined location prevents the separation layer from bonding to another separation layer which is located in the stack beneath the separation layer being gripped when that separation layer is moved by the handling apparatus. In particular, in the case of a rectangular separation layer, the at least one predetermined location may be provided or situated in a corner of the separation layer.

Preferably, the gripping device is configured to grip the separation layer at a plurality of predetermined locations, which are each located adjacent to an edge of the separation layer and which are arranged circumferentially distributed. For example, the handling apparatus may be in the form of a vacuum gripper and the at least one gripping device may be in the form of a bellows suction cup. This allows the separation layer to be securely gripped or handled.

According to a preferred embodiment, the handling apparatus has at least one spacer which extends parallel with a surface normal (i.e., an imaginary line perpendicular to a flat surface) of the separation layer and which is configured to at least partially space apart the separation layer from the handling apparatus. Such a spacer has the advantage that, when the separation layer is raised by the handling apparatus, the spacer acts as a tipping point, whereby the separation layer can be bent more easily.

Preferably, the at least one spacer is provided on the handling apparatus so as to be located beside or adjacent to the at least one gripping device. In particular, the at least one spacer can be associated with a respective gripping device. For example, the at least one spacer may be arranged between the at least one slot and the at least one gripping device. Furthermore, the at least one spacer and the at least one gripping device may be arranged so that the spacer is adjacent to the at least one slot when the separation layer is gripped by the handling apparatus. Such positioning of the spacer enables reliable bending of the separation layer during handling of a particular separation layer and for the slot to open or expand so that air can flow between the adjacent or overlapping separation layers and thereby release any bonding or adhesion between the separation layers.

In particular, the spacer makes it possible for the separation layer not to be raised uniformly or evenly when the separation layer is gripped using suction and/or raised by the gripping devices of the handling apparatus. Instead, one portion of the separation layer is fixed in position at the location at which the at least one spacer contacts the separation layer so that the at least one gripping device, which is placed at the predetermined location, partially moves another portion of the separation layer upwardly. The at least one spacer thereby acts as a tipping point which allows one or more portions of the separation layer, for example, the center of the separation layer and/or a region beside the at least one slot, to be pressed downwardly. It is thereby possible for any bonding or adhesion between the separation layer being raised and the separation layer beneath the raised layer to be released or prevented.

According to a preferred embodiment, the at least one gripping device is configured to be positioned obliquely with respect to a surface normal of the separation layer in a state in which the at least one gripping device grips the separation layer. For example, the handling apparatus may be in the form of a vacuum gripper and the at least one gripping device may be in the form of a bellows suction cup. Placing the at least one gripping device obliquely enables the separation layer to be gripped and handled securely despite the separation layer bending and without any risk of the separation layer becoming separated from the gripping device.

Additional advantages and advantageous embodiments are set out in the description, the drawings and the claims. In this case, in particular the combinations, which are set out in the description and in the drawings, of the features are merely exemplary so that the features may also be present individually or in other combinations.

### BRIEF DESCRIPTION OF THE SEVERAL VIEWS OF THE DRAWINGS

The invention is intended to be described in greater detail below with reference to exemplary embodiments which are illustrated in the drawings. In this case, the exemplary embodiments and the combinations which are shown in the exemplary embodiments are merely exemplary and are not intended to determine the protective scope of the invention. The protective scope is defined only by the appended claims. In the drawings:

FIG. 1 is a side view of a system for handling separation layers in a production process according to one embodiment;

FIG. 2 is a schematic plan view of one separation layer of the system for handling separation layers in a production process according to one embodiment;

FIG. 3 a bottom view of a handling apparatus of the system for handling separation layers in a production process according to one embodiment; and

FIG. 4 is a side view of the handling apparatus of a system for handling separation layers in a production process according to one embodiment.

### DETAILED DESCRIPTION OF THE INVENTION

Identical or functionally equivalent elements are denoted below with the same reference numerals.

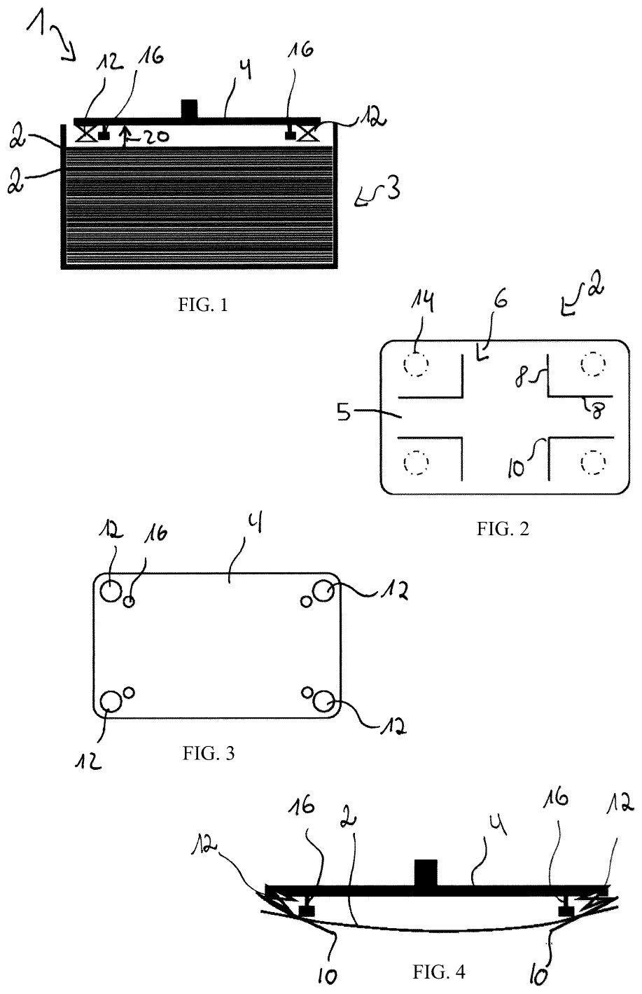

A system I for handling separation layers 2 in a production process is described below with reference to FIGS. 1-4. The system I basically comprises at least one separation layer 2 and a handling apparatus 4 configured to move the separation layer(s) 2, each separation layer 2 being formed as a sheet 5 having opposing upper and lower surfaces (neither indicated). To this end, the handling apparatus 4 is configured to raise a separation layer 2 from a stack 3 comprising a plurality of separation layers 2 (FIG. 2) and to move the separation layer 2. The handling apparatus 4 may be, for example, a vacuum gripper and may have a plurality of gripping devices 12 which are each in the form of a bellows suction cup.

The separation layer 2 is produced or fabricated from a flexible plastic material, such as for example, acrylonitrile butadiene styrene copolymer (“ABS”), and preferably has a thickness between 1 mm and 5 mm, more preferably from 2 mm to 3 mm. In the exemplary embodiment shown, the separation layer 2 has a rectangular shape with four edges and four corners (none indicated). Alternatively, the separation layer 2 may have any desired or appropriate shape, such as for example, a circular or oval shape with a single outer edge, triangular, pentagonal, etc.

The separation layer 2 has in its face a plurality of slots 6 which are arranged in a distributed manner. Preferably, each slot 6 preferably extends entirely between the opposing surfaces of the sheet 5 of the separation layer 2, such that each slot 6 is a “through” opening, but may alternatively extend only partially from one surface toward the opposing surface.

In the embodiment shown, the separation layer 2 is generally rectangular (i.e., having four sides) and has L-shaped slots 6 with two legs 8 which meet or intersect at a tip or corner 10. Preferably, the L-shaped slots 6 are arranged on the layer 2 such that each leg 8 of each L-shaped slot 6 is arranged parallel with one side of the separation layer 2 and the tip 10 of the L-shaped slot 6 is directed toward a center (not indicated) of the separation layer 2. Alternatively, the separation layer 2 may also have more or less than the preferred four slots 6. For example, the separation layer 2 may have two, three, five, six or even greater than six slots 6 and/or the slots 6 may have any other appropriate shape, such as having a single straight leg, a single curved leg, an enclosed geometric shape, e.g., triangular, rectangular, etc. (no alternatives shown).

As shown in FIG. 2, the four preferred slots 6 are each arranged in a region of a separate corner of the separation layer 2 so that the tip 10 of each slot 6 faces away from the corner of the separation layer 2 and toward the center of the layer 2.

In order to raise or lift one separation layer 2 from the stack 3, the handling apparatus 4 has at least one gripping device 12 which is configured to grip the separation layer 2 at one predetermined “grip” location 14 on the layer 2, as indicated in FIG. 2. Preferably, the handling apparatus 4 includes a plurality of the gripping devices 12 and each gripping device 12 is configured to grip the separation layer 2 at a separate one of a plurality of predetermined locations 14 on the layer 2. Further, the number of slots 6 of each separation layer 2 is preferably equal to the number of predetermined locations 14 and the predetermined locations 14 are each located adjacent to a separate one of the slots 6 in the separation layer 2. As can be seen in FIG. 2, in a preferred embodiment, each slot 6 partially surrounds a separate one of the predetermined locations 14 at a predetermined spacing distance from the location 14.

FIG. 3 shows the handling apparatus 4 from below, that is to say, the side or end of the handling apparatus 4 which cooperates or engages with the separation layer 2. The handling apparatus 4 preferably further includes at least one spacer 16 located adjacent to the at least one gripping device 12, the spacer 16 extending parallel with a surface normal 20 of the separation layer 2 (See FIGS. 1 and 4). In the depicted embodiment, the handling apparatus 4 includes a plurality of spacers 16, a separate one of the spacers 16 being provided for each gripping device 12 and each slot 6, respectively. That is, the number of slots 6, the number of spacers 16 and the number of gripping devices 12 is preferably identical or equal.

The spacers 16 are configured to at least partially space apart the separation layer 2 from the handling apparatus 4. This has the advantage that, when the separation layer 2 is drawn in using suction and raised by the handling apparatus 4, preferably by the gripping devices 12 of the handling apparatus 4, the separation layer 2 is not subjected to a uniform suction. Instead, the separation layer 2 is fixed in position at the locations at which the spacers 16 contact the layer 2, while the gripping devices 12 placed at the corners of the separation layer 2 move the corners of the separation layer 2 upwardly. Each spacer 16 thereby acts as a “tipping point”, whereby the center of the separation layer 2 and the tip/corner 10 of each one of the slots 6 are pressed downwardly, as shown in FIG. 4. Thereby, any bonding or adhesion between the lifted or raised separation layer 2 and the separation layers 2 beneath the one layer 2 being lifted is released.

In order that the corners of the separation layer 2 may be pressed or pulled upwardly during the raising action and so that each spacer 16 may act as a tipping point, each gripping device 12 is preferably configured to be positioned obliquely relative to a surface normal 20 of the separation layer 2 when the gripping device 12 engages with the separation layer 2. Such oblique positioning of each gripping device 12 enables the separation layer 2 to be securely gripped and handled, despite any bending thereof, without any risk of detachment of the separation layer 2 from the gripping device 12.

In summary, a bending of the separation layer 2 may be achieved by providing one or more slots 6, preferably formed as L-shaped slots 6, which ensure a high movability in each region between the tip/corner 10 of one slot 6 and a proximal corner of the separation layer 2, and at least one gripping device 12 which moves the corner of the separation layer 2 upwardly or in the direction of the handling apparatus 4.

Each spacer 16, which acts as a tipping point, enables the center of the separation layer 2 and the corners 10 of the slots 6 to be pressed downwardly. Due to the center of the separation layer 2 and the corners 10 of the slots 6 being pressed downwardly, the separation layer 2 in the stack 3 located beneath the layer 2 engaged by the handling apparatus 4 is fixed in position while the uppermost separation layer 2 is raised by the handling apparatus 4. In summary, it can be said that the bending of the separation layer 2 generates a force which overcomes the adhesive force, for example caused by a liquid (e.g., lubricant) disposed between the separation layers 2, and which causes separation of the bent separation layer 2 from the layer 2 in the stack 3 beneath that particular separation layer 2.

Representative, non-limiting examples of the present invention were described above in detail with reference to the attached drawings. This detailed description is merely intended to teach a person of skill in the art further details for practicing preferred aspects of the present teachings and is not intended to limit the scope of the invention.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter. The invention is not restricted to the above-described embodiments, and may be varied within the scope of the following claims.

### LIST OF REFERENCE NUMERALS

1 System
2 Separation layer
3 Stack
4 Handling apparatus
5 Sheet
6 Slot
8 Leg
10 Corner
12 Gripping device
14 Predetermined location
16 Spacer
20 Surface normal

I claim:

1. A system for handling separation layers in a production process, the system comprising:
at least one separation layer having at least one slot; and
a handling apparatus configured to move the separation layer.

2. The system according to claim 1, wherein the handling apparatus is a vacuum gripper.

3. The system according to claim 1, wherein the at least one slot is angular or in the form of a circular arc.

4. The system according to claim 1, wherein the handling apparatus includes at least one gripping device configured to grip the separation layer at least at one predetermined location.

5. The system according to claim 4, wherein the handling apparatus further includes at least one spacer provided adjacent to the at least one gripping device, the at least one spacer extending parallel with a surface normal of the separation layer and being configured to at least partially space apart the separation layer from the handling apparatus.

6. The system according to claim 5, wherein the at least one spacer and the at least one gripping device are arranged such that the at least one spacer is located adjacent to the at least one slot when the separation layer is gripped by the handling apparatus.

7. The system according to claim 6, wherein the at least one slot at least partially surrounds the at least one predetermined location at a predetermined spacing.

8. The system according to claim 4, wherein the separation layer has an outer edge and the at least one predetermined location on the separation layer includes a plurality of predetermined locations located adjacent to the edge of the separation layer and distributed circumferentially.

9. The system according to claim 4, wherein the at least one gripping device is configured to be positioned obliquely with respect to a surface normal of the separation layer when the at least one gripping device engages with the separation layer.

10. The system according to claim 4, wherein the at least one gripping device is in the form of a bellows suction cup.

11. The system according to claim 1, wherein the at least one slot of the separation layer includes a plurality of slots, the plurality of slots being arranged uniformly and/or symmetrically.

12. The system according to claim 1, wherein the at least one separation layer is formed of a flexible plastic material.

13. The system according to claim 12, wherein the flexible plastic material is acrylonitrile butadiene styrene copolymer (“ABS”).
